(19) United States
(12) Patent Application Publication
(10) Pub. No.: US 2018/0241450 A1
(43) Pub. Date: Aug. 23, 2018

(54) ACCESS POINT CONTROLLED STEERING OF WIRELESS STATIONS

(71) Applicant: QUALCOMM Incorporated, San Diego, CA (US)

(72) Inventors: Manish SHUKLA, Milpitas, CA (US); Ajay PATHAK, Fremont, CA (US)

(21) Appl. No.: 15/439,139

(22) Filed: Feb. 22, 2017

(51) Int. Cl. H04B 7/06; H04L 29/12; H04B 17/318

(52) U.S. Cl. CPC H04B 7/0617; H04W 88/08; H04B 17/318; H04L 61/6022

(57) ABSTRACT

Aspects of the present disclosure implement techniques that allow the serving AP to obtain signal quality information over backhaul link from one or more target APs as it relates to one or more STAs that are currently being served by the serving AP. The target APs may measure signal quality between the target AP and the STA by observing uplink communication between the STA and the serving AP that may be broadcasted over the network. Based on the signal quality information received by the serving AP from one or more target APs, the serving AP may determine whether the signal quality for the STA would improve if the STA shifts from the serving AP to the target AP.

### BACKGROUND

The present disclosure relates generally to telecommunications, and specifically to techniques for steering (e.g., routing) wireless stations (STAs), by a serving access point (AP), to a target AP from a plurality of target APs that may provide improved signal quality, data rate, reliability, quality of service (QoS) to the STA.

The deployment of wireless local area networks (WLANs) in the home, the office, and various public facilities is commonplace today. Such networks typically employ a wireless AP that connects a number of wireless STAs in a specific locality (e.g., home, office, public facility, etc.) to another network, such as the Internet or the like. In a dense WLAN deployment, a number of APs may be in close vicinity to the STAs. A STA, in conventional WLAN architecture, is responsible for discovering potential target APs in the vicinity of the STA by conducting periodic scans of WLAN channels. Based on the scanning, the STA can determine whether one or more target APs may offer improved signal quality over the serving AP. If the target AP provides improved signal quality, the STA may initiate a handover from the serving AP to the target AP.

However, in some cases, the STA may maintain connection with a serving AP even when a target AP may provide measurable improvement in signal quality (e.g., when the STA moves away from the serving AP and closer to the target AP). In the current systems (e.g., conventional WLAN architecture), STAs collect information (e.g., signal quality information) from multiple APs and make the decision whether to stay with the current serving AP or switch (e.g., handover) to another target AP. Because the STAs are alone responsible for identifying potential target APs and determine whether or not to handover, the serving AP may not be aware of the signal quality metrics experienced at the STA. As such, the serving AP may not be capable to instruct the STA regarding which target AP is best (e.g., best signal quality) to switch to even when the STA is experiencing degraded signal quality with the serving AP.

One solution to the above-identified problem is addressed by employing STAs that support the recent Institute of Electrical and Electronics Engineering (IEEE) 802.11k/v functionality. Particularly, in order to offload the responsibility of determining which AP to use from the STA to a serving AP, the IEEE 802.11k/v standard allows the STAs to collect information (e.g., signal quality) regarding multiple APs and send the collected information to the serving AP such that the serving AP may make the determination for the STA. However, legacy STAs that do not support IEEE 802.11k/v capabilities are unable to provide such information regarding multiple APs to the serving AP upon request. As such, for the legacy STAs, the above offloading solution discussed above cannot be implemented for such devices.

### SUMMARY

Aspects of the present disclosure solve the above-identified problem by implementing techniques that allow the serving AP to obtain signal quality information over backhaul link from one or more target APs as it relates to one or more STAs that are currently being served by the serving AP. The target APs may measure signal quality between the target AP and the STA by observing uplink communication between the STA and the serving AP that may be broadcasted over the network. Based on the signal quality information received by the serving AP from one or more target APs, the serving AP may determine whether the signal quality for the STA would improve if the STA shifts from the serving AP to the target AP.

In response to the determining, the serving AP may steer the STA to the identified target AP. For the purposes of the present disclosure, the term “steer” or “routing” may refer to notification transmitted by the serving AP that identifies one or more target APs that the STA should establish communication with. Further, in order to force the STA to disconnect from the serving AP and establish communication with the identified target AP, aspects of the present disclosure include techniques for the serving AP to disable servicing of the STA. Accordingly, techniques of the present disclosure allow legacy STAs (e.g., STAs that do not support IEEE 802.11k/v functionality) to be routed to an AP that offers the greatest signal quality and QoS.

In one example of the present disclosure, a method for wireless communication is disclosed. The method may include receiving, at a target AP, a signal monitoring request from a serving AP. The method may further include triggering, at the target AP in response to receiving the signal monitoring request, monitoring of received signal strength indicator (RSSI) of a STA in communication with the serving AP. The method may further include determining, at the target AP, a signal quality between the target AP and the STA based on the RSSI monitoring. The method may also include transmitting information associated with the signal quality to the serving AP.

In another example, an apparatus for wireless communication is disclosed. The apparatus may include a processor and a memory coupled to the processor. The memory may include instructions executable by the processor to receive, at a target AP, a signal monitoring request from a serving AP. The instructions may be further executable by the processor to trigger, at the target AP in response to receiving the signal monitoring request, monitoring of received signal strength indicator (RSSI) of a STA in communication with the serving AP. The instructions may be further executable by the processor to determine, at the target AP, a signal quality between the target AP and the STA based on the RSSI monitoring. The instructions may be further executable by the processor to transmit information associated with the signal quality to the serving AP.

In yet another example, a computer-readable medium storing computer executable code for wireless communications. The computer-readable medium may include code to receive, at a target AP, a signal monitoring request from a serving AP. The computer-readable medium may further include code to trigger, at the target AP in response to receiving the signal monitoring request, monitoring of received signal strength indicator (RSSI) of a STA in communication with the serving AP. The computer-readable medium may further include code to determine, at the target AP, a signal quality between the target AP and the STA based on the RSSI monitoring. The computer-readable medium may further include code to transmit information associated with the signal quality to the serving AP.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is a conceptual diagram illustrating an example of a wireless local area network (WLAN) deployment;

FIGS. 2A and 2B are call flow diagrams of example of techniques for determining whether to steer STAs in accordance with aspects of the present disclosure;

FIG. 3 is a schematic diagram of a device including an aspect of an AP that may implement various aspects of the present disclosure;

FIG. 4 illustrates one example of a flowchart that shows aspects of the serving AP steering STAs in accordance with various aspects of the present disclosure; and

FIG. 5 illustrates one example of a flowchart that shows aspects of the target AP measuring and transmitting signal quality information over the backhaul link to the serving AP in accordance with various aspects of the present disclosure.

### DETAILED DESCRIPTION

Techniques of the present disclosure allow the monitoring and processing functionalities associated with identifying target APs to be offloaded from the STA to the network of APs for all devices, including legacy STAs. As such, a STA may preserve the processing and battery resources while being routed by the APs towards the target AP (or maintaining communication with the serving AP) that provides improved signal quality. Particularly, features of the present disclosure address the problem discussed above in that legacy STAs that do not support IEEE 802.11k/v capabilities are unable to provide signal information associated with multiple APs to a serving AP. Consequently, the offloading techniques are generally unable to be implemented on the legacy STAs. In such situations, the legacy STAs are alone responsible for identifying which AP (e.g., serving AP or target AP) to establish communication with and when to switch between the plurality of APs in the vicinity. However, such limitations may adversely impact the quality of service (QoS) experienced at the STA because some STAs may maintain communication with an AP even when the STA may be better served by switching communication to another AP in the vicinity (e.g., range extender). These situations may occur, for example, when the legacy STA moves away from serving AP towards one or more target APs (e.g., in home setting when a user of the STA moves from one floor to a different floor that may have a separate range extender).

Thus, aspects of the present disclosure solve this problem by implementing techniques that allow the serving AP to obtain signal quality information over backhaul link from one or more target APs as it relates to one or more STAs that are currently being served by the serving AP. The target APs may measure signal quality between the target AP and the STA by observing uplink communication between the STA and the serving AP that may be broadcasted over the network. Based on the signal quality information received by the serving AP from one or more target APs, the serving AP may determine whether the signal quality for the STA would improve if the STA shifts from the serving AP to the target AP. Additionally the serving AP may steer or route the legacy STAs to a target AP that provides improved signal quality than the serving AP may offer.

Various concepts will now be described more fully hereinafter with reference to the accompanying drawings. These concepts may, however, be embodied in many different forms by those skilled in the art and should not be construed as limited to any specific structure or function presented herein. Rather, these concepts are provided so that this disclosure will be thorough and complete, and will fully convey the scope of these concepts to those skilled in the art. The detailed description may include specific details. However, it will be apparent to those skilled in the art that these concepts may be practiced without these specific details. In some instances, well known structures and components are shown in block diagram form in order to avoid obscuring the various concepts presented throughout this disclosure.

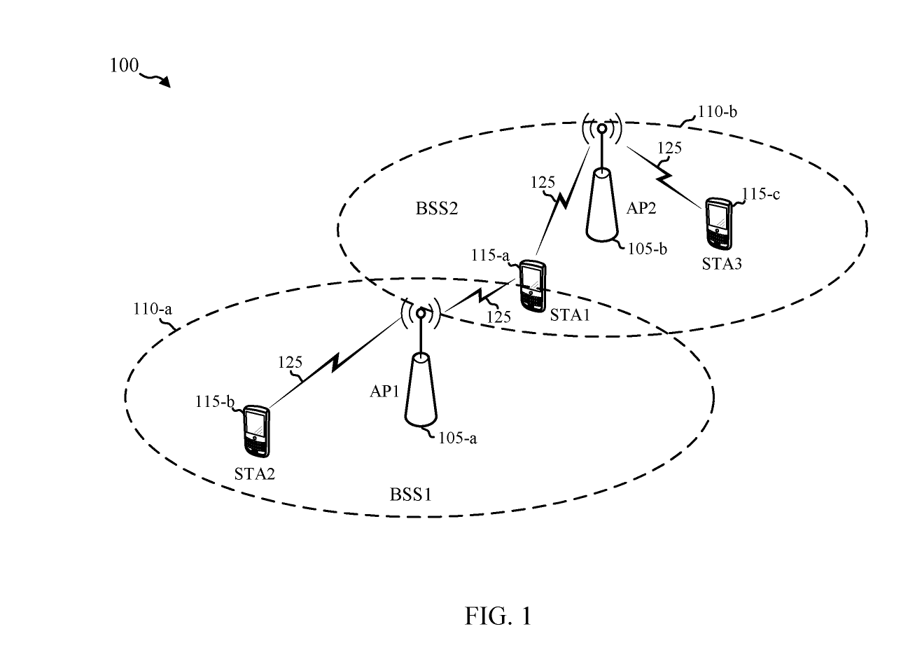

FIG. 1 is a conceptual diagram 100 illustrating an example of a wireless local area network (WLAN) deployment in connection with various techniques described herein. The WLAN may include one or more access points (APs) and one or more mobile stations (STAs) associated with a respective AP. In this example, there are two APs deployed: AP1 105-a in basic service set 1 (BSS1) and AP2 105-b in BSS2, which may be referred to as an OBSS. AP1 105-a is shown as having at least two associated STAs (STA1 115-a and STA2 115-b) and coverage area 110-a, while AP2 105-b is shown having at least two associated STAs (STA1 115-a and STA3 115-c) and coverage area 110-b. The STAs and AP associated with a particular BSS may be referred to as members of that BSS. In the example of FIG. 1, the coverage area of AP1 105-a may overlap part of the coverage area of AP2 105-b such that STA1 115-a may be within the overlapping portion of the coverage areas. The number of BSSs, APs, and STAs, and the coverage areas of the APs described in connection with the WLAN deployment of FIG. 1 are provided by way of illustration and not of limitation.

In some examples, the APs (e.g., AP1 105-a and AP2 105-b) shown in FIG. 1 are generally fixed terminals that provide backhaul services to STAs 115 within its coverage area or region. In some applications, however, the AP may be a mobile or non-fixed terminal. The STAs (e.g., STA1 115-a, STA2 115-b and STA3 115-c) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, or any other suitable terminology. The various concepts described throughout this disclosure are intended to apply to all suitable wireless apparatus regardless of their specific nomenclature.

Each of STA1 115-a, STA2 115-b, and STA3 115-c may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications link 125. The APs can send frames or packets to their respective STAs and receive frames or packets from their respective STAs to communicate data and/or control information (e.g., signaling). Each of AP1 105-a and AP2 105-b can establish a communications link 125 with an STA that is within the coverage area of the AP. Communications link 125 can comprise communications channels that can enable both uplink and downlink communications. When connecting to an AP, an STA can first authenticate itself with the AP and then associate itself with the AP. Once associated, a communications link 125 may be established between the AP 105 and the STA 115 such that the AP 105 and the associated STA 115 may exchange frames or messages through a direct communications channel. It should be noted that the wireless communication system, in some examples, may not have a central AP (e.g., AP 105), but rather may function as a peer-to-peer network between the STAs. Accordingly, the functions of the AP 105 described herein may alternatively be performed by one or more of the STAs 115.

In some examples, a STA (e.g., STA1 115-a) may be in vicinity of a plurality of APs (e.g., first AP 105-a that may be a serving AP) and a second AP 105-b that may be a potential target AP. At the edge of the coverage area 110-a of the first AP 105-a, the signal quality between the first AP 105-a and the STA1 115-a may deteriorate. In such situations, the STA 115-a may be better served by the second AP 105-b. However, conventional techniques where the STA 115-a may not support IEEE 802.11k/v functionality, the STA 115-a may not be able to communicate to the first AP 105-a the signal metric information between the second AP 105-b and the STA 115-a. Further, because the STA 115-a may maintain its connection with the first AP 105-a, the STA 115-a may suffer with signal quality.

Features of the present disclosure allow the first AP 105-a to request signal quality information between one or more target APs 105 and the STA 115-a such that the first AP 105-a may determine whether the STA would be better served maintaining its connection with the first AP 105-a or switching to one or more target APs 105 (e.g., second AP 105-b). Accordingly, in some examples, the first AP 105-a may issue a request to one or more target APs (e.g., second AP 105-b) to inquire about signal quality between the second AP 105-b and the STA 115-a. The second AP 105-b, without requesting the STA 115-a to provide a signal quality report (e.g., RSSI) may activate smart monitoring virtual access point (VAP) functionality at the second AP 105-b to independently monitor uplink communication between the STA 115-a and the first AP 105-a. The VAP functionality allows an AP 105 to receive and process the received packets (e.g., uplink packets from STA) without acting on the received packets. Thus, VAP functionality allows the AP 105-to function in “shadow mode” for the purposes of monitoring and calculating signal quality. Based on the monitoring, the second AP 105-b may calculate the signal quality that may be obtainable if the STA 115-a would transition to the second AP 105-b. Accordingly, the second AP 105-b may transmit the signal quality information to the first AP 105-a in order to allow the first AP 105-a to determine whether the STA 115-a would be better served by maintaining communication with the first AP 105-a or by switching to the second AP 105-b.

In some examples, in order to identify the “ideal” AP (e.g., AP that provides the better signal quality), the first AP 105-a may compare a first signal quality (e.g., signal quality between the first AP 105-a and the STA 115-a) and a second signal quality (e.g., signal quality between the second AP 105-b and the STA 115-a). In some examples, the term “signal quality” may be any measure of measuring channel between the AP 105 and the STA 115, including but not limited to signal strength, signal to noise ratio (SNR), data rate, reliability, QoS, etc. If the first signal quality exceeds the second signal quality, the first AP 105-a may continue maintaining communication with the first AP 105-a. However, if the second signal quality exceeds a first signal quality, the first AP 105-a may steer the STA 115-a towards the second AP 105-b by transmitting a steering message to the STA 115-a. The steering message may identify the target AP to which the STA 115-a should establish communication with.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for performing operations based on modifications and enhancements to dynamic sensitivity control may be applicable to any suitable wireless network regardless of the coverage range and the wireless access protocols utilized.

In some aspects, one or more APs (105-a and 105-b) may transmit on one or more channels (e.g., multiple narrowband channels, each channel including a frequency bandwidth) a beacon signal (or simply a “beacon”), via a communications link 125 to STA(s) 115 of the wireless communication system, which may help the STA(s) 115 to synchronize their timing with the APs 105, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, wireless devices (e.g., STA 115 and/or AP 105) may, in order to increase reuse of the spectrum, transmit on top of transmissions coming from an OBSS and refrain from transmitting on top of transmissions coming from the same BSS (also known as in-BSS). To enable a wireless device to determine whether a transmission is from the same BSS as the wireless device or from an OBSS, some packets may have a color code/information that identifies the BSS from which the packets originated, in some cases the BSSID field is also included along with BSS color. Color code/information may be a BSS identifier (BSSID) or a partial BSSID or separate value advertised by the AP. When the wireless device receives a packet with color information, the wireless device may determine if the packet is associated with the same BSS as the wireless device, and may therefore defer transmissions, or if the packet is associated with an OBSS, in which case the wireless device may reuse the spectrum.

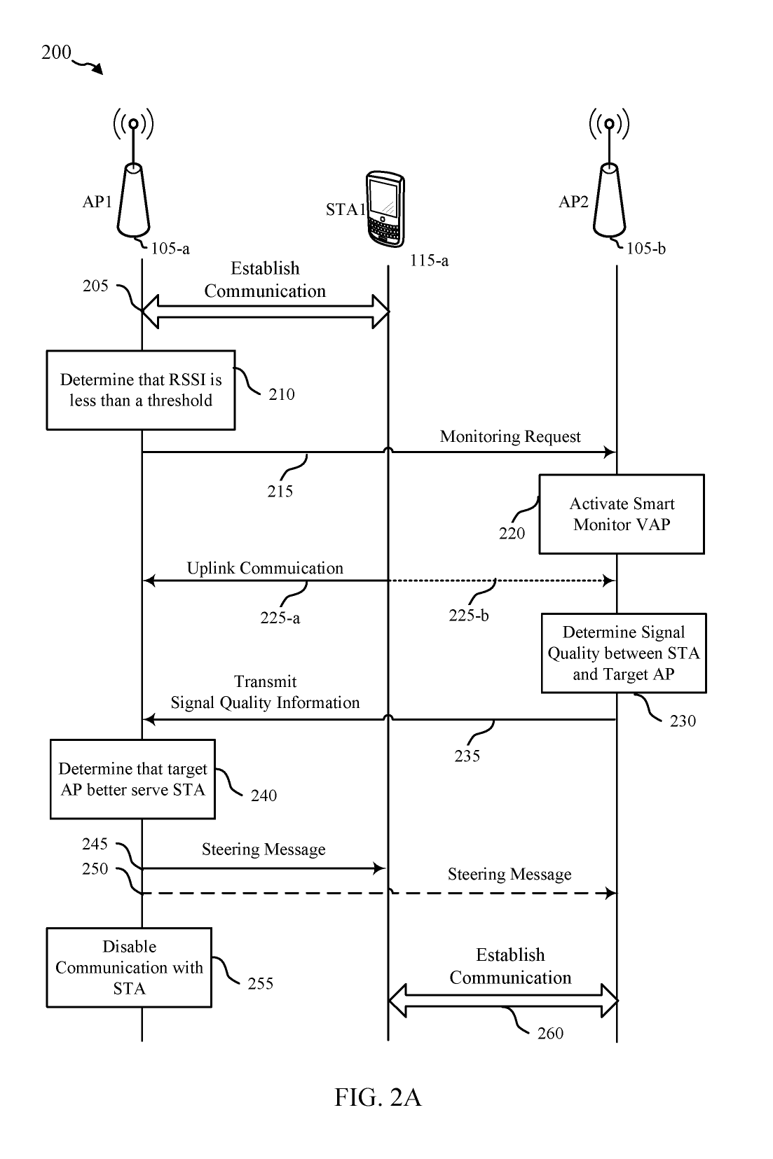

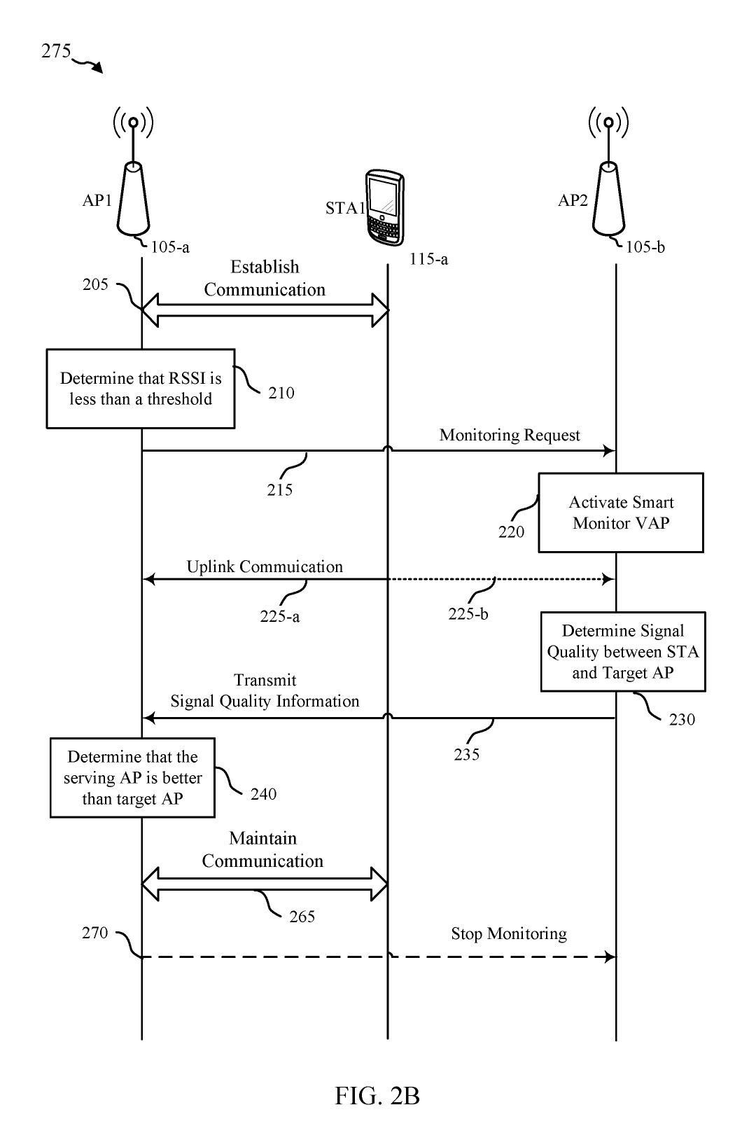

FIG. 2A is a call flow diagram 200 for steering a STA 115-a to an AP 105 (e.g., serving AP 105-a or target AP 105-b) that may provide improved signal quality to the STA 115-a. In some examples, the STA 115-a may be an example of a STA 115 discussed with reference to FIG. 1. Similarly, the first AP 105-a (e.g., serving AP) and the second AP 105-b (e.g., target AP) may be examples of one or more APs 105 described with reference to FIG. 1 above. While FIG. 2A illustrates one additional AP (e.g., second AP 105-b), the disclosure is not limited in that regard and the serving AP 105 (first AP 105-a) may communication with multiple APs 105 to determine whether to steer the STA 115 to another AP 105 and which one of the plurality of available APs 105 to select as a target AP 105.

At 205, the first AP 105-a (e.g., serving AP) and the STA 115-a may be in communication. However, as the STA 115-a moves further from the first AP 105-a (e.g., near the edge of the first AP 105-a effective range), the signal quality between the first AP 105-a and the STA 115 may invariably begin to deteriorate. At 210, the first AP 105-a may determine that the RSSI between the first AP 105-a and the STA 115-a is less than a threshold. Accordingly, at 215, the first AP 105-a may generate a signal monitoring request to inquire from one or more target APs (e.g., second AP 105-b) whether the STA 115-a would be better served by transitioning to the target AP.

At 220, the second AP 105-b that receives the signal monitoring request may activate the smart monitor VAP in order to monitor uplink transmissions 225-a between the STA 115 and the first AP 105-a. Particularly, because the STA 115-a may broadcast the uplink transmissions, one or more APs 105 in the vicinity may observe 225-b (or receive) the transmitted communication. Based on the received packets, the second AP 105-b may determine the signal quality between the STA 115-a and the second AP 105-b. In some examples, the second AP 105-b may only measure the signal quality based on the observed communication between the STA 115-a and the first AP 105-a. In other words, the second AP 105-b does not simply forward or transmit RSSI information received from the STA 115 at the second AP 105-b to the first AP 105-b over the backhaul link. Instead, features of the present disclosure do not require the STA 115-a to prepare a report for the benefit of either AP 105. By relying on the processing capabilities of the second AP 105-b, the STA 115 may prevent unnecessary drain on the battery and processing resources at the mobile device.

At 235, the second AP 105-b may transmit signal quality information over the backhaul link to the first AP 105-a. In some examples, the transmission of the signal quality information from the second AP 105-b and the first AP 105-a may occur while a monitoring timer at the second AP 105-b is still active (e.g., has not expired). At 240, the first AP 105-a may determine whether the second AP 105-b may serve the STA 115 better than the first AP 105-a in terms of signal quality. As discussed above, the term “signal quality” may include one or more of signal strength, signal to noise ratio (SNR), data rate, reliability, or QoS, etc. Thus, in some examples, the first AP 105-a may compare measured first signal quality between the first AP 105-a and the STA 115 against the second signal quality information received from the second AP 105-b that specifies the second signal quality between the second AP 105-b and the STA 115.

If the second signal quality exceeds the first signal quality, the first AP 105-a, at 245, may transmit a steering message to the STA 115 notifying the STA 115 to handover to the second AP 105-b. The steering message may identify the address of the second AP 105-b to allow the STA 115 to locate and connect to the second AP 105-b. In some examples, the first AP 105-a, at 250, may also transmit a steering message to the second AP 105-b indicating that the second AP 105-b should establish communication with the STA 115. In some examples, in order to steer the STA 115 from the first AP 105-a to the second AP 105-b, the first AP 105-a, at 255, may additionally disable communication with the STA 115. Accordingly, at 260, the STA 115 may establish communication with the second AP 105-b.

With reference to FIG. 2B, if, however, at 240, the first AP 105-a determines that the first signal quality exceeds the second signal quality (e.g., serving AP offers better signal quality than any of available target APs), the serving AP 105, at 265, may determine to maintain communication between the STA 115-a and the first AP 105-a. In such situations, the first AP 105-a, at 270, may transmit a stop monitoring trigger to the second AP 105-b such that the second AP 105-b does not continue to monitor and report signal quality information to the first AP 105-a.

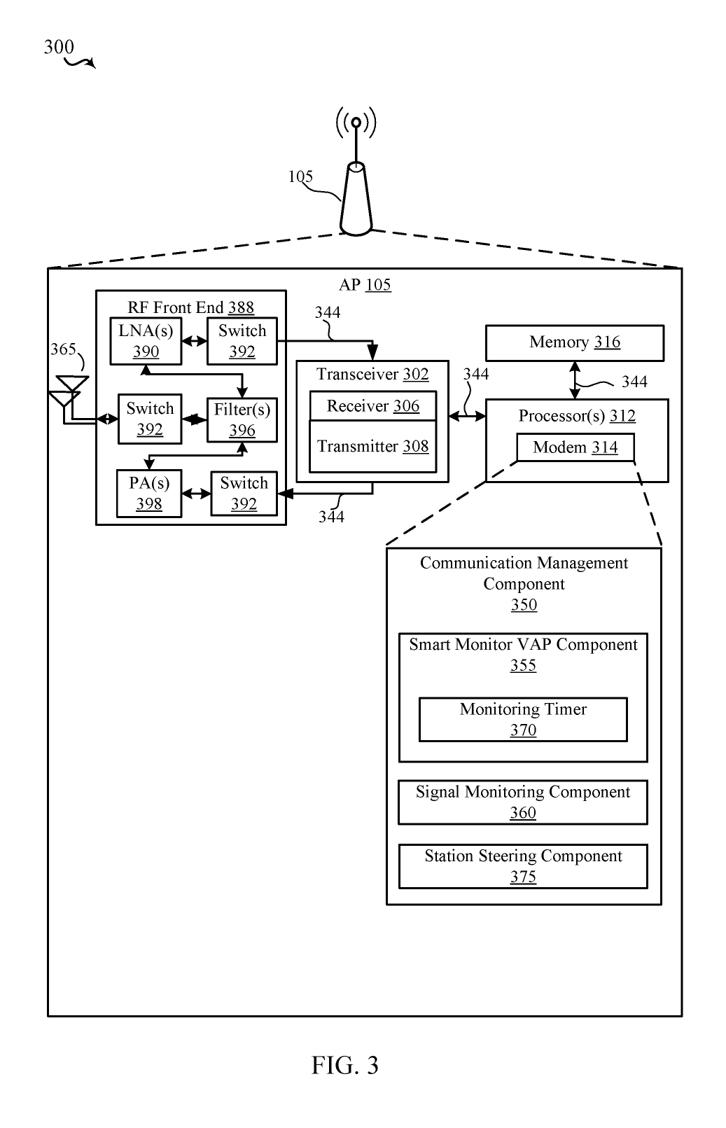

FIG. 3 describes hardware components and subcomponents of an AP 105 for implementing one or more methods (e.g., methods 400 and 500) described herein in accordance with various aspects of the present disclosure. The AP 105 may be an example of a target AP or the serving AP. As discussed above, when the AP 105 is acting as a serving AP, the components and subcomponents described herein may identify an AP that may provide one or more STAs with improved signal quality and steer the STAs towards the suitable target AP. In the instance that the AP 105 is acting as a target AP, the components (e.g., communication management component 350) may receive the monitoring requests from the serving AP 105 and measure signal quality between the target AP and the STA based on uplink communication from the STA to the serving AP (e.g., by overhearing broadcast transmission).

One example of an implementation of AP 105 may include a variety of components, some of which have already been described above, but including components such as one or more processors 312 and memory 316 and transceiver 302 in communication via one or more buses 344, which may operate in conjunction with communication management component 350 to enable one or more of the functions described herein related to including one or more methods of the present disclosure. Further, the one or more processors 312, modem 314, memory 316, transceiver 302, RF front end 388 and one or more antennas 365, may be configured to support voice and/or data calls (simultaneously or non-simultaneously) in one or more radio access technologies.

In an aspect, the one or more processors 312 can include a modem 314 that uses one or more modem processors. The various functions related to communication management component 350 may be included in modem 314 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 314 associated with communication management component 350 may be performed by transceiver 302.

Also, memory 316 may be configured to store data used herein and/or local versions of applications or communication management component 350 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining communication management component 350 and/or one or more of its subcomponents, and/or data associated therewith, when AP 105 is operating at least one processor 312 to execute communication management component 350 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one STA 115 or other APs 105. For example, the receiver 306 may receive a monitoring request from a serving AP. Additionally, receiver 306 may process such received signals, and also may obtain measurements of the signals, such as, but not limited to, Ec/Io, SNR, RSRP, RSSI, etc. Transmitter 308 may include hardware, firmware, and/or software code executable by a processor for transmitting data, the code comprising instructions and being stored in a memory (e.g., computer-readable medium). For example, when the AP 105 is acting as a serving AP, the transceiver 302 may be responsible for generating and transmitting monitoring requests to the target AP when the signal quality between the serving AP and at least one STA falls below a signal threshold. A suitable example of transceiver 302 may including, but is not limited to, an RF transmitter.

Moreover, in an aspect, AP 105 may include RF front end 388, which may operate in communication with one or more antennas 365 and transceiver 302 for receiving and transmitting radio transmissions, for example, wireless communications transmitted by at least one other AP 105 or wireless transmissions transmitted by STA 115. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 688 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that AP 105 can communicate with, for example, one or more STAs 115 or one or more cells associated with one or more AP 105. In an aspect, for example, modem 314 can configure transceiver 602 to operate at a specified frequency and power level based on the UE configuration of the AP 105 and the communication protocol used by modem 314.

In an aspect, modem 314 can be a multiband-multimode modem, which can process digital data and communicate with transceiver 302 such that the digital data is sent and received using transceiver 302. In an aspect, modem 314 can be multiband and be configured to support multiple frequency bands for a specific communications protocol. In an aspect, modem 414 can be multimode and be configured to support multiple operating networks and communications protocols. In an aspect, modem 314 can control one or more components of AP 105 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on configuration information associated with AP 105 as provided by the network during cell selection and/or cell reselection.

The communication management component 350 may include a smart monitor VAP component 355 for activating a virtual functionality at the target AP 105 that monitors broadcast uplink communication between a STA 115 and a serving AP. Thus, although the STA 115 may have an established communication with a serving AP, the target AP meanwhile may overhear one or more broadcast transmissions from the STA 115 to the serving AP 105. The target AP may “overhear” a message that is intended for a different AP (e.g., serving AP) if the target AP is in vicinity of the transmitting device. In such instance, the target AP, upon receiving the uplink broadcast transmission at the antenna 365, may at least partially decode the received packet to identify the intended recipient (e.g., MAC address of the AP or STA the message is the intended recipient). If the target AP 105 is not the intended recipient of the received message, the target AP 105 may utilize the smart monitor VAP component 355 to forward the information to the signal monitoring component 360. In some examples, the signal monitoring component 360 upon being triggered by the smart monitor VAP component 355 may measure RSSI of a STA that is in communication with the serving AP. The transceiver 302 of the AP 105 may transmit information associated with the signal quality to the serving AP 105 that issued the monitoring request to the serving AP.

In some examples, the smart monitor VAP component 355 may further include a monitoring timer 370. The monitoring timer 370 may be preconfigured to a set time or receive timing information from the serving AP. Accordingly, the monitoring timer 370 may be triggered (e.g., begin decrementing based on either the preconfigured time value or the one received from the serving AP) when the smart monitor VAP component 355 is activated. In some aspects, the signal monitoring component 360 may perform the monitoring of the RSSI of the STA until expiration of the monitoring timer.

The communication management component 350 may also include a station steering component 375 that may be utilized when the AP 105 is acting as a serving AP. The station steering component 375 may continuously or periodically determine the signal quality between the serving AP and one or more STAs 115 that are being served by the serving AP. When the signal quality between the serving AP and at least one STA 115 falls below (or is less than) a signal threshold, the station steering component 375 may generate a signal monitoring request in order to enquire about the signal quality between potential target APs and at least one STA. As such the station steering component 375 may identify one or more possible target APs that may better serve at least one STA in terms of improved signal quality, increased reliability, higher data rate, etc.

Once the target AP has been identified, the station steering component 375 may direct or instruct at least one STA that is currently being served (e.g., established communication) by the serving AP to disconnect from the serving AP and establish communication with the identified target AP. In some aspects, in order to force the STA to switch (or handover), the station steering component 375 may disable communication between the serving AP and the STA such that the STA may be forced to handover. As such, the station steering component 375 may prevent the directed STA to reconnect with the serving AP for a predetermined time period. Upon the expiration of the predetermined time period, the station steering component 375 may reauthorize the STA to connect to the serving AP if, and when, the first signal quality between the serving AP and the STA is greater than the second signal quality between the target AP and the STA.

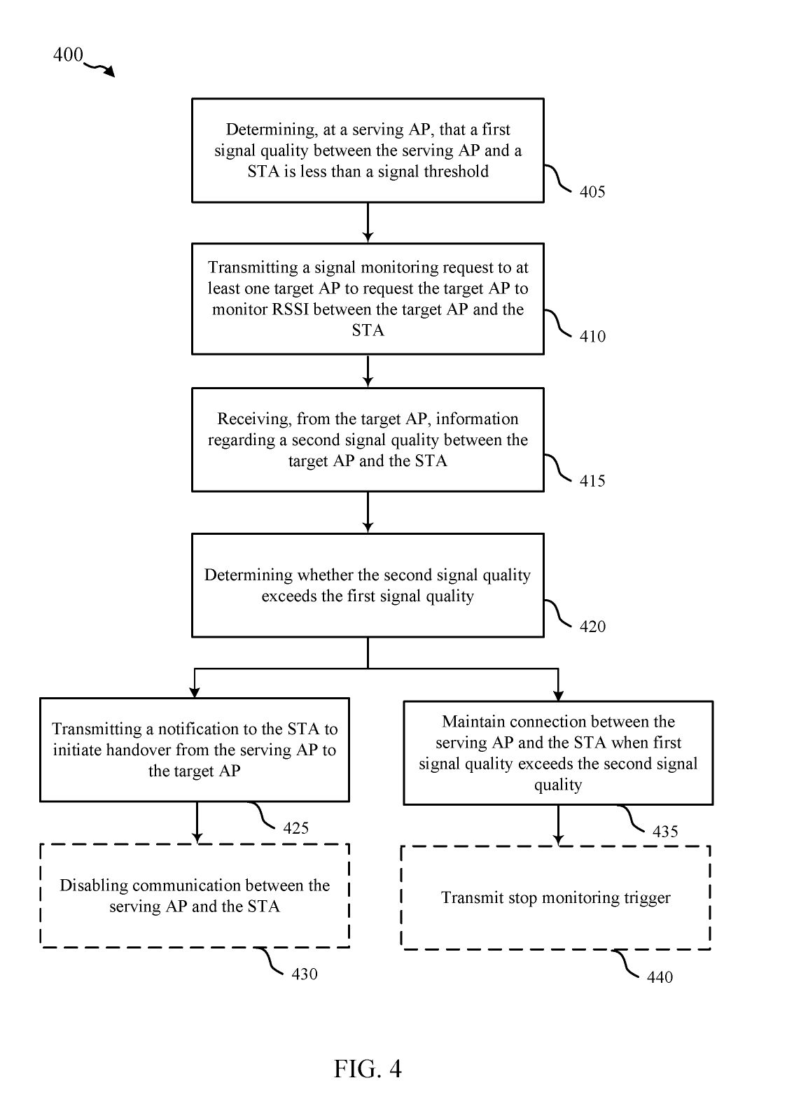

FIG. 4 is a flowchart conceptually illustrating an example of a method 400 of wireless communication implemented by a serving AP, in accordance with aspects of the present disclosure. For clarity, the method 400 is described below with reference to AP 105 of FIGS. 1-3.

At block 405, the method 400 may include determining, at a serving AP, that a first signal quality between the serving AP and a STA is less than a signal threshold. Aspects of block 405 may be performed by the communication management component 350, and more particularly the signal monitoring component 360 described with reference to FIG. 3.

At block 410, the method 400 may include transmitting a signal monitoring request to at least one target AP to request the target AP to monitor RSSI between the target AP and one or more STAs. In some examples, the one or more STAs for which the serving AP requests signal quality information regarding may be identified by the serving AP by the MAC address of the one or more STAs. In some examples, the one or more STAs may have an established communication connection with the serving AP when the serving AP requests signal monitoring from the target AP. Aspects of block 410 may be performed by the transceiver 302 described with reference to FIG. 3.

At block 415, the method 400 may include receiving, from the target AP, information regarding a second signal quality between the target AP and the STA. Aspects of block 415 may be performed by receiver 306 described with reference to FIG. 3.

At block 420, the method 400 may include determining whether the second signal quality (e.g., signal quality between target AP and the STA) exceeds the first signal quality (e.g., signal quality between serving AP and the STA). In some examples, even if the second signal quality exceeds the first signal quality, the communication management component 350 may further determine whether the improvement between the signal quality exceeds a predetermined threshold. Particularly, if the improvement is only marginal, the communication management component 350 may continue serving the STA in order to prevent the STA from cycling between the two APs. However, if the improvement from the first signal quality to the second signal quality exceeds the predetermined threshold, the communication management component 350 may determine to steer the STA towards the target AP. Aspects of block 420 may be performed by station steering component 375 described with reference to FIG. 3.

If the serving AP 105 determines to steer the STA 115 towards one or more possible target APs, the serving AP, at block 425, may transmit a notification to the STA to initiate handover from the serving AP to the target AP. In some examples, the notification may identify the target AP to which the STA to establish communication with based on the MAC address or BSSID of the target AP. Aspects of 425 may be performed by the transceiver 302 described with reference to FIG. 3.

Further, at block 430, the method 400 may optionally include disabling communication between the serving AP and the STA. Specifically, the serving AP, in order to force the STA to steer towards the target AP may disable communication between the serving AP and the STA. As such, the STA may be prevented from successfully communicating with the serving AP. In some aspects where multiple potential target APs are within the vicinity of the STA, the serving AP may also transmit notifications to each of the plurality of target APs to also disable their communication with the particular STA such that the STA is forced to establish communication with the target AP selected by the serving AP. Aspects of block 430 may be performed by station steering component 375 described with reference to FIG. 3.

However, if at block 420, the serving AP determines that the first signal quality exceeds the second signal quality (or if the improvement of the second signal quality is only marginal—less than a threshold improvement), the serving AP, at block 435, may determine to maintain connection between the serving AP and the STA. Accordingly, at block 440, the method may include transmitting stop monitoring trigger to the target AP. Aspects of block 435 and 440 may be performed by station steering component 375 and the transceiver 302 described with reference to FIG. 3.

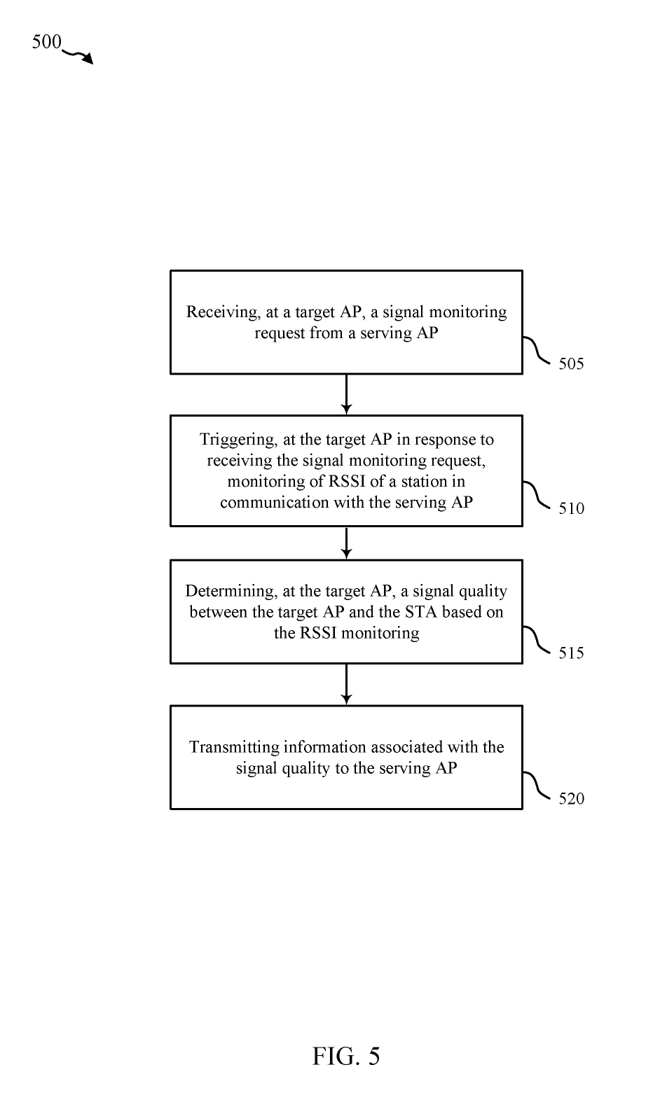

FIG. 5 is a flowchart conceptually illustrating an example of a method 500 of wireless communication implemented by a target AP, in accordance with aspects of the present disclosure. For clarity, the method 500 is described below with reference to AP 105 of FIGS. 1-3.

At block 505, the method 500 may include receiving, at the target AP, a signal monitoring request from a serving AP. In some examples, the signal monitoring request may include a MAC address of the STA for which the serving AP requests signal quality information regarding. Thus, based on the MAC address, the target AP can focus the transceiver to receive uplink frames transmitted by the specified STA. Additionally or alternatively, the signal monitoring request may also include a timing information associated with a monitoring timer. Upon receiving the timing information, the target AP may trigger the monitoring timer (e.g., decrement from the time specified in the timing information). In some examples, the target AP may perform the monitoring of the RSSI of the STA until expiration of the monitoring timer. Aspects of 505 may be performed by receiver 306 described with reference to FIG. 3.

At block 510, the method may include triggering, at the target AP in response to receiving the signal monitoring request, monitoring of RSSI of a STA in communication with the serving AP. In some examples, triggering the monitoring of the RSSI of a STA at the target AP may comprise activating a VAP functionality at the target AP that monitors broadcast uplink communication between the STA and the serving AP. In other words, while the target AP does not completely decode and process the uplink communication from the STA to the serving AP, the target AP may utilize the uplink communication observed at the target AP in order to measure the signal quality between the target AP and the STA. Aspects of 510 may be performed by smart monitor VAP component 355 described with reference to FIG. 3.

At block 515, the method may include determining, at the target AP, a signal quality between the target AP and the STA based on the RSSI monitoring. In some examples, determining the signal quality may include analyzing the broadcast uplink communication between the STA and the serving AP to identify the signal quality between the target AP and the STA. Aspects of 515 may be performed by signal monitoring component 360 described with reference to FIG. 3.

At block 520, the method may include transmitting information associated with the signal quality to the serving AP. In some examples, the serving AP may determine which AP (e.g., serving AP or target AP) provides improved signal quality for the STA identified by the MAC address in the signal monitoring request above. However, in order to preserve the processing capabilities of both the serving AP and the target AP, the monitoring and sharing of the signal information may be limited by the monitoring timer at the target AP such that the target AP does not continue monitoring and transmitting signal quality information indefinitely. As such, the target AP may monitor and transmit signal quality information to the serving AP until either the monitoring timer expires or receives a stop monitoring trigger from the serving AP. Based on either event, the target AP may terminate the monitoring of the RSSI. In some examples, the method may further include receiving, in response to the transmitting the information to the serving AP, a steering message from the serving AP that requests the target AP to establish communication with the STA. Accordingly, the target AP may establish communication with the STA if the serving AP determines that the STA may be better served by the target AP. Aspects of 520 may be performed by the transceiver 302 described with reference to FIG. 3.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method for wireless communication, comprising:
receiving, at a target access point (AP), a signal monitoring request from a serving AP;
triggering, at the target AP in response to receiving the signal monitoring request, monitoring of received signal strength indicator (RSSI) of a station (STA) in communication with the serving AP;
determining, at the target AP, a signal quality between the target AP and the STA based on the RSSI monitoring; and
transmitting information associated with the signal quality to the serving AP.

2. The method of claim 1, further comprising:
receiving, in response to transmitting the information to the serving AP, a steering message from the serving AP instructing the target AP to establish communication with the STA; and
establishing communication with the STA based on the steering message.

3. The method of claim 1, wherein triggering the monitoring of the RSSI of the STA at the target AP comprises:
activating a virtual access point (VAP) functionality at the target AP that monitors broadcast uplink communication between the STA and the serving AP.

4. The method of claim 3, wherein determining the signal quality between the target AP and the STA comprises:
analyzing, at the target AP, the broadcast uplink communication between the STA and the serving AP to identify the signal quality.

5. The method of claim 1, wherein the signal monitoring request from the serving AP includes a media access control (MAC) address of the STA to identify the STA from a plurality of STAs for the monitoring.

6. The method of claim 1, wherein the signal monitoring request from the serving AP includes timing information associated with a monitoring timer.

7. The method of claim 6, wherein the monitoring timer is triggered based on the timing information received from the serving AP, wherein the target AP performs the monitoring of the RSSI of the STA until expiration of the monitoring timer.

8. The method of claim 1, further comprising:
receiving, at the target AP, a stop monitoring trigger from the serving AP; and
terminating the monitoring of the RSSI of the STA in response to receiving the stop monitoring trigger.

9. An apparatus for wireless communication, comprising:
a processor; and
a memory coupled to the processor, wherein the memory includes instructions executable by the processor to:
receive, at a target access point (AP), a signal monitoring request from a serving AP;
trigger, at the target AP in response to receiving the signal monitoring request, monitoring of received signal strength indicator (RSSI) of a station (STA) in communication with the serving AP;
determine, at the target AP, a signal quality between the target AP and the STA based on the RSSI monitoring; and
transmit information associated with the signal quality to the serving AP.

10. The apparatus of claim 9, wherein the instructions are further executable by the processor to:
receive, in response to transmitting the information to the serving AP, a steering message from the serving AP instructing the target AP to establish communication with the STA; and
establish communication with the STA based on the steering message.

11. The apparatus of claim 9, wherein the instructions to trigger the monitoring of the RSSI of the STA at the target AP are further executable by the processor to:
activating a virtual access point (VAP) functionality at the target AP that monitors broadcast uplink communication between the STA and the serving AP.

12. The apparatus of claim 11, wherein the instructions to determine the signal quality between the target AP and the STA are further executable by the processor to:
analyzing, at the target AP, the broadcast uplink communication between the STA and the serving AP to identify the signal quality.

13. The apparatus of claim 9, wherein the signal monitoring request from the serving AP includes a media access control (MAC) address of the STA to identify the STA from a plurality of STAs for the monitoring.

14. The apparatus of claim 9, wherein the signal monitoring request from the serving AP includes timing information associated with a monitoring timer.

15. The apparatus of claim 14, wherein the monitoring timer is triggered based on the timing information received from the serving AP, wherein the target AP performs the monitoring of the RSSI of the STA until expiration of the monitoring timer.

16. The apparatus of claim 9, wherein the instructions are further executable by the processor to:
receive, at the target AP, a stop monitoring trigger from the serving AP; and
terminate the monitoring of the RSSI of the STA in response to receiving the stop monitoring trigger.

17. A computer-readable medium storing computer executable code for wireless communications, comprising code for:
receiving, at a target access point (AP), a signal monitoring request from a serving AP;
triggering, at the target AP in response to receiving the signal monitoring request, monitoring of received signal strength indicator (RSSI) of a station (STA) in communication with the serving AP;
determining, at the target AP, a signal quality between the target AP and the STA based on the RSSI monitoring; and
transmitting information associated with the signal quality to the serving AP.

18. The computer-readable medium of claim 17, further comprising code for:
receiving, in response to transmitting the information to the serving AP, a steering message from the serving AP instructing the target AP to establish communication with the STA; and
establishing communication with the STA based on the steering message.

19. The computer-readable medium of claim 17, wherein the code for triggering the monitoring of the RSSI of the STA at the target AP further comprises code for activating a virtual access point (VAP) functionality at the target AP that monitors broadcast uplink communication between the STA and the serving AP; and
wherein the code for determining the signal quality between the target AP and the STA comprises code for analyzing, at the target AP, the broadcast uplink communication between the STA and the serving AP to identify the signal quality.

20. The computer-readable medium of claim 17, wherein the signal monitoring request from the serving AP includes timing information associated with a monitoring timer, wherein the monitoring timer is triggered based on the timing information received from the serving AP, wherein the target AP performs the monitoring of the RSSI of the STA until expiration of the monitoring timer.
